(19) United States
(12) Patent Application Publication
(10) Pub. No.: US 2022/0379765 A1
(43) Pub. Date: Dec. 1, 2022

(54) SYSTEMS AND METHODS FOR ALLOCATION OF CHARGING RATES BASED ON VEHICLE CHARACTERISTICS

(71) Applicant: Volta Charging, LLC, San Francisco, CA (US)

(72) Inventors: Ramsey Meyer, San Francisco, CA (US); Bradford Crist, San Francisco, CA (US); Jeffrey Kinsey, San Francisco, CA (US)

(21) Appl. No.: 17/709,070

(22) Filed: Mar. 30, 2022

Related U.S. Application Data
(60) Provisional application No. 63/193,567, filed on May 26, 2021.

(51) Int. Cl. B60L 53/65; B60L 53/64; B60L 58/12

(52) U.S. Cl. CPC B60L 53/65; B60L 53/64; B60L 58/12

(57) ABSTRACT

Systems and methods are provided herein for administering services (e.g., charging rates, charging costs, user experiences, etc.) to an electric vehicle based on a characteristic of the electric vehicle. This may be accomplished by an electric vehicle charging station (EVCS) charging an electric vehicle and using one or more sensors to capture information about the electric vehicle. The EVCS can using the captured information to determine a characteristic of the electric vehicle. The EVCS can then use the determined characteristic of the electric vehicle to administer a service. For example, an EVCS may capture an image of an electric vehicle and use image recognition to determine the model (i.e., vehicle characteristic) of the electric vehicle. The EVCS can then charge the electric vehicle using a first charging rate (i.e., service) based on the model of the electric vehicle.

### BACKGROUND

The present disclosure relates to computer-implemented techniques for charging electric vehicles, and in particular to techniques for allocating resources to electric vehicles based on information corresponding to the electric vehicles.

### SUMMARY

As more consumers transition to electric vehicles, there is an increasing demand for electric vehicle charging stations (EVCSs). These EVCSs usually supply electric energy, either using cables or wirelessly, to the batteries of electric vehicles. For example, a user can connect their electric vehicle via cables of an EVCS, and the EVCS supplies electrical current to the user's electric vehicle. The cables and control systems of the EVCSs can be housed in kiosks in locations to allow a driver of an electric vehicle to park the electric vehicle close to the EVCS and begin the charging process. These kiosks may be placed in areas of convenience, such as in parking lots at shopping centers, in front of commercial buildings, or in other public places. These kiosks often comprise a display that can be used to provide media items to the user to enhance the user's charging experience. Consequently, passers-by, in addition to users of the EVCS, may notice media items displayed by the EVCS. Traditionally, EVCSs provide the same services (e.g., charging rate, charging cost, user experience, etc.) to each electric vehicle that is connected to the EVCS without considering additional factors (e.g., electrical grid load, vehicle information, estimated charge time, etc.), which results in inefficient electric vehicle charging.

For example, charging an electric vehicle's battery too quickly can damage the battery, reducing the battery's performance capacity and shortening the battery's life cycle. Slowing the charging rate of a battery is beneficial as it can result in prolonged battery life and more efficient battery performance over the course of the battery's life. Different electric vehicles also have different specifications, battery sizes, battery types, etc., which can affect the optimal charging rate for the batteries of the different electric vehicles. For example, an electric vehicle with a smaller battery may not require charging at the same rate as an electric vehicle with a larger battery. Providing the same charging rate to all electric vehicles regardless of estimated charge time or the electric vehicle's requirements may result in inefficient charging and unnecessary wear on the electric vehicle's battery.

In another example, during “peak” periods (times when the electrical grid's electric supply is more scarce), electric companies will charge more for EVCSs to charge an electric vehicle. EVCSs using the same charging rate and charging price regardless of the time of day or the vehicle's requirements results in increased costs to the EVCSs and increased load on the electrical grid.

In another example, a first media item (e.g., coffee sale) may be more desirable to a user than a second media item (e.g., movie ticket sale) due to the user's dwell time. For example, if a user plans to charge their electric vehicle at the EVCS for two hours, the user may be more interested in learning about the movie ticket sale, while a user planning to charge their electric vehicle for ten minutes may be more interested in learning about the coffee sale. EVCSs providing the same media item on the EVCSs' display regardless of estimated charge time results in suboptimal user experiences.

Various systems and methods described herein address these problems by providing a method for allocating services based on characteristics of the vehicle being charged. To allocate services based on characteristics of an electric vehicle, an EVCS must first be able to accurately identify characteristics corresponding to the electric vehicle. As described herein, one methodology to identify characteristics about an electric vehicle is for an EVCS to use one or more sensors to capture information about the electric vehicle. For example, these sensors may be image sensors (e.g., one or more cameras), ultrasound sensors, depth sensors, Infrared (IR) cameras, Red Green Blue (RGB) cameras, Passive Infrared (PIR) camera, heat IR, proximity sensors, radar, tension sensors, near field communication (NFC) sensors, and/or any combination thereof. After the one or more sensors capture information about the electric vehicle being charged, the EVCS can use this information to determine the electric vehicle's characteristics (e.g., model, make, tire pressure, specifications, condition, etc.). For example, if the EVCS determines that a first vehicle corresponds to a vehicle type that has a 100 kilowatt-hour (kWh) battery, the EVCS can charge the electric vehicle at a first charging rate. If the EVCS determines that a second vehicle corresponds to a vehicle type that has an 80-kWh battery, the EVCS can charge the second electric vehicle at a second charging rate. The EVCS may select the first charging rate according to the optimal charging rate for an electric vehicle with a 100-kWh battery and select the second charging rate according to the optimal charging rate for an electric vehicle with an 80-kWh battery. In another example, if the EVCS determines that a first vehicle's battery is 90% charged, the EVCS can charge the first electric vehicle at a first charging rate. If the EVCS determines that a second vehicle's battery is 5% charged, the EVCS can charge the second electric vehicle at a second charging rate. The second charging rate may be faster than the first charging rate because the EVCS determines that the second vehicle's battery is almost out of charge. Because the first charging rate is slower, the first vehicle is not subjected to unnecessarily fast charging rates, resulting in a prolonged lifespan of the first vehicle's battery.

The EVCS can also use estimated charge times to more efficiently provide services to electric vehicles. The estimated charge times can be used in conjunction with and/or derived from information captured by the one or more sensors. The EVCS can also determine an estimated charge time based on user information (e.g., user's calendar, user feedback, user profile, user patterns, etc.). The EVCS can determine an estimated charge time based on user information and/or vehicle characteristics. For example, if the EVCS determines that a user purchased a movie ticket for a showing at a nearby theater that starts around the time of arrival, the EVCS can determine a first charging rate based on the first estimated charge time (e.g., two hours). If the EVCS determines that a user of a second electric vehicle purchased a coffee for pickup nearby, the EVCS can determine a second charging rate based on the second estimated charge time (e.g., ten minutes). The second charging rate is faster than the first charging rate because the EVCS determines that the second vehicle's estimated charge time is less than the first vehicle's estimated charge time. As the user watches the movie, the first vehicle is not subjected to unnecessarily fast charging rates, resulting in a prolonged lifespan of the first vehicle's battery.

In another example, a user pattern may be that users of electric vehicles spend more time charging their electric vehicles when their electric vehicles are low on charge. Accordingly, if the EVCS determines that a first electric vehicle's battery is 5% charged and a second vehicle's battery is 90% charged, the EVCS can determine that the first electric vehicle's estimated charge time will be longer than the second electric vehicle's estimated charge time. The EVCS can use the first and second estimated charge times to customize media items to display to the users of the electric vehicles. For example, the EVCS will determine that a first media item (e.g., movie ticket sale) may be more desirable to the user of the first electric vehicle because the first media item corresponds to an activity with a longer time frame. The first media item is more desirable because the first electric vehicle's battery takes longer to optimally charge so the first user has more available time. The EVCS will determine that a second media item (e.g., coffee sale) may be more desirable to the user of the second electric vehicle because the second media item corresponds to an activity that can be completed more quickly. The second media item is more desirable to the user of the second electric vehicle because the second electric vehicle's battery does not require as much time to optimally charge, so the second user has less available time. The EVCS can also customize media items to display based on other vehicle characteristics. For example, the EVCS can determine the depth of the tire tread of an electric vehicle using the one or more sensors and customize media items based on the condition of the tire tread. In some applications, machine learning algorithms can be used to classify treadwear, such as U.S. Application No. 63/177,787, the entire disclosure of which is hereby incorporated by reference herein. If the EVCS uses a machine learning algorithm to determine that the tire tread is too shallow, the EVCS can display media items (e.g., tire tread notification, tire sales, etc.) relating to the tire tread condition.

The EVCS can also use location information (e.g., electrical grid information, site information, etc.) to more efficiently provide services to electric vehicles. For example, using electrical grid information, the EVCS can determine that a first vehicle arriving at the EVCS at a peak electrical time (e.g., noon in the middle of summer in Arizona) will be charged at a first charging rate. The EVCS can also determine that a second vehicle arriving at a non-peak electrical time (e.g., 8:00 am in the middle of fall in Arizona) will be charged at a second charging rate. The second charging rate is faster than the first charging rate because the EVCS determines that the first vehicle's charging rate needs to be slower to decrease load on the electrical grid during the peak time and decrease electrical costs to the EVCS. The grid information can be used in conjunction with the information captured by the one or more sensors, the estimated charge times, and/or any other information described herein. For example, using electrical grid information and a first estimated charge time (e.g., two hours) the EVCS determines that a first vehicle arriving at the EVCS will be charged at a first charging rate. The first charging rate may be to provide little to no charge for the first hour and a half of the two-hour time frame when the electrical grid load is at a peak. The first charging rate may then provide a more rapid charge for the last half hour of the first estimated charge time during a non-peak electric time. The EVCS determines the first charging rate to reduce load on the electrical grid during the peak time and decrease electrical costs. Site information can also be used to more efficiently provide services to electric vehicles. Site information relates to the parameters of the EVCS's location. For example, newer locations (malls, shopping centers, etc.) may have more advanced electrical architecture allowing for higher output of electrical energy compared to locations with older electrical architecture. Accordingly, sites with higher output may allow for faster charging rates compared to sites with lower outputs.

The EVCS can leverage machine learning to identify electric vehicle characteristics and user information using the data collected by the one or more sensors. Traditionally, training a machine learning algorithm to identify objects in a frame requires a significant amount of human interaction. For example, an individual would have to sort through a significant number of images to identify images with certain objects. The individual would then have to characterize the objects in the identified images and use this information to train the machine learning algorithm. This manual process is tedious and time-consuming. The present invention can leverage the data collected by the EVCS to create a more tailored data set, optimizing the training of a machine learning algorithm used in conjunction with the EVCS.

As described herein, one methodology to more efficiently train a machine learning algorithm uses known events and vehicle characteristics to train the machine learning algorithm with minimal to no human interaction. Known events (e.g., when the EVCS begins charging the electric vehicle, when the user checks in, etc.) may be used to narrow the time frame of analyzed data received from the one or more sensors of the EVCS. For example, when the EVCS begins charging the electric vehicle, the data received from the EVCS's one or more sensors will likely include video of the electric vehicle being charged. Further, because the EVCS is in a location with known parameters, there are fewer variables included in the data received from the one or more sensors. Accordingly, when the EVCS determines that charging has begun, the EVCS can flag the video data received around that time period as video data to be used to train the machine learning algorithm. The flagged video data can be used in conjunction with vehicle characteristics (e.g., vehicle model, vehicle make, etc.) to increase the efficiency of the training of the machine learning process. For example, some electric vehicles and EVCSs support ISO 15118, which allows a user to plug their electric vehicle into an EVCS and begin charging without inputting any additional information. ISO 15118 is a communication interface, which, among other things, can identify the make and model of an electric vehicle to an EVCS. When an electric vehicle that supports ISO 15118 begins charging (known event), the EVCS can flag the video data received from the sensors and also receive vehicle characteristics (make and model of the electric vehicle) using ISO 15118. The vehicle characteristics paired with the flagged video data allows for more efficient training of the machine learning algorithm. Accordingly, machine learning algorithms learn more quickly and/or can be trained using less data.

### BRIEF DESCRIPTION OF THE DRAWINGS

The below and other objects and advantages of the disclosure will be apparent upon consideration of the following detailed description, taken in conjunction with the accompanying drawings, and in which:

FIG. 1 shows an illustrative diagram of a system for allocating services based on characteristics of the electric vehicle being charged, in accordance with some embodiments of the disclosure;

FIGS. 2A and 2B show illustrative diagrams of a system for allocating services based on characteristics of the electric vehicle being charged, in accordance with some embodiments of the disclosure;

FIGS. 3A and 3B illustrate an EVCS used for allocating services based on characteristics of the electric vehicle being charged, in accordance with some embodiments of the disclosure;

FIG. 4 shows an illustrative block diagram of an EVCS system, in accordance with some embodiments of the disclosure;

FIG. 5 shows an illustrative block diagram of a user equipment device system, in accordance with some embodiments of the disclosure;

FIG. 6 shows an illustrative block diagram of a server system, in accordance with some embodiments of the disclosure;

FIG. 7 is an illustrative flowchart of a process for determining a charging rate based on a characteristic of an electric vehicle, in accordance with some embodiments of the disclosure;

FIG. 8 is an illustrative flowchart of a process for flagging data to be used in training a machine learning algorithm, in accordance with some embodiments of the disclosure; and

FIG. 9 is an illustrative flowchart of a process for training a machine learning algorithm using data collected by an EVCS, in accordance with some embodiments of the disclosure.

### DETAILED DESCRIPTION

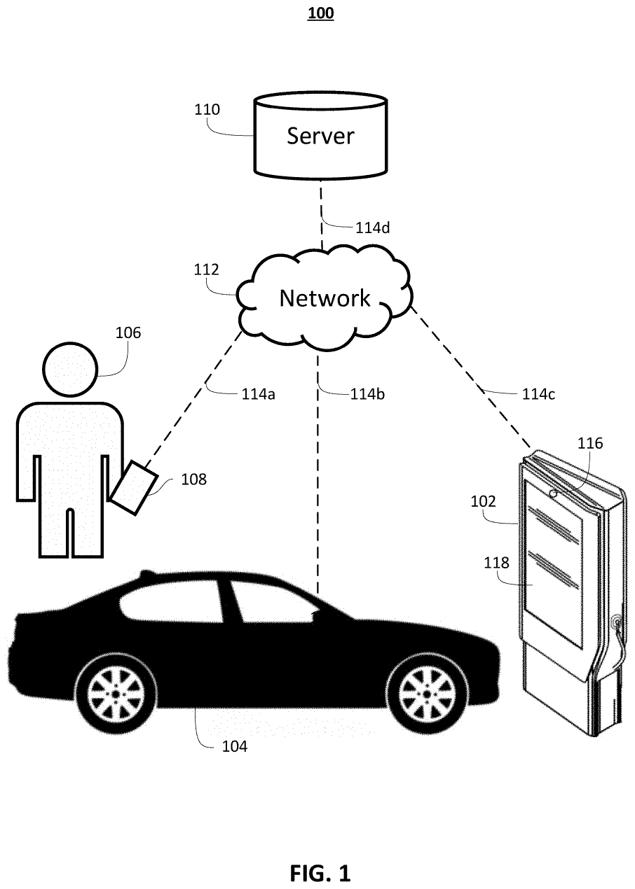

FIG. 1 shows an illustrative diagram of a system 100 for allocating services based on characteristics of an electric vehicle 104 being charged, in accordance with some embodiments of the disclosure. In some embodiments, the EVCS 102 provides an electric charge to the electric vehicle 104 via a wired connection, such as a charging cable, or a wireless connection (e.g., wireless charging). The EVCS 102 may be in communication with the electric vehicle 104 or a user device 108 belonging to a user 106 (e.g., a driver, passenger, owner, renter, or other operator of the electric vehicle 104) who is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user, 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, EVCSs, and/or electric vehicles, so that the items may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the devices may also communicate with each other directly through an indirect path via a communications network. The communications network may be one or more networks including the internet, a mobile phone network, mobile voice or data network (e.g., a 4G, 5G, or LTE network), cable network, public switched telephone network, or other types of communications network or combinations of communications networks. In some embodiments, a communications network path comprises one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. In some embodiments, a communications network path can be a wireless path. Communication with the devices may be provided by one or more communication paths but is shown as a single path in FIG. 1 to avoid overcomplicating the drawing.

In some embodiments, the EVCS 102 allocates services to the electric vehicle 104 and/or user 106 based on characteristics of the electric vehicle 104 being charged. To allocate services based on characteristics of the electric vehicle 104, the EVCS 102 must first be able to accurately identify characteristics corresponding to the electric vehicle 104. In some embodiments, the EVCS 102 uses one or more sensors to capture information about the electric vehicle. For example, these sensors may be image (e.g., optical) sensors, sensors (e.g., one or more cameras 116), ultrasound sensors, depth sensors, IR cameras, RGB cameras, PIR cameras, heat IR, proximity sensors, radar, tension sensors, NFC sensors, and/or any combination thereof.

In some embodiments, one or more cameras 116 are configured to capture one or more images of an area proximal to the EVCS 102. For example, a camera may be configured to obtain a video or capture images of an area corresponding to a parking spot associated with the EVCS 102, a parking spot next to the parking spot of the EVCS 102, and/or walking paths (e.g., sidewalks) next to the EVCS 102. In some embodiments, the camera 116 may be a wide-angle camera or a 360° camera that is configured to obtain a video or capture images of a large area proximal to the EVCS 102. In some embodiments, the camera 116 may be positioned at different locations on the EVCS 102 than that is shown. In some embodiments, the camera 116 works in conjunction with other sensors. In some embodiments, the one or more sensors (e.g., camera 116) can detect external objects within a region (area) proximal to the EVCS 102. In some embodiments, the one or more sensors are configured to determine a state of the area proximal to the EVCS 102. In some embodiments, the state may correspond to detecting external objects, detecting the lack of external objects, etc. In some embodiments, the external objects may be living or nonliving, such as people, kids, animals, vehicles, shopping carts, toys, etc.

In some embodiments, after the one or more sensors capture information, the EVCS 102 can use this information to determine the electric vehicle 104's characteristics (e.g., model, make, specifications, condition, etc.). In some embodiments, using the data collected from the one or more sensors, the EVCS 102 can identify electric vehicle characteristics by leveraging machine learning. The EVCS 102 can use the determined electric vehicle characteristics to allocate services. For example, using the camera 116, the EVCS 102 can determine the make and model of the electric vehicle 104. The EVCS 102 can then access a database to determine the optimal charging rate corresponding to the determined make and model and charge the electric vehicle 104 using the determined charging rate. In some embodiments, the database may be stored in the EVCS 102, the server 110, or a combination thereof. In some embodiments, the EVCS 102 receives images of the license plate of the electric vehicle 104 from the camera 116. In some embodiments, the EVCS 102 reads the license plate (e.g., using optical character recognition) and uses the license plate information to determine vehicle characteristics of the electric vehicle 104. In some embodiments, the EVCS 102 uses a database to lookup vehicle characteristics of the electric vehicle 104 using the license plate information. For example, the database may comprise public records (e.g., public registration information linking license plates to vehicle characteristics), collected information (e.g., entries linking license plates to vehicle characteristics based on data inputted by a user), historic information (entries linking license plates to vehicle characteristics based on the EVCS 102 identifying vehicle characteristics related to one or more license plates in the past), and/or similar such information.

In some embodiments, the EVCS 102 uses user information to determine vehicle characteristics of the electric vehicle 104. For example, the user 106 may input vehicle characteristics into a profile that is accessible by the EVCS 102. In some embodiments, when the EVCS 102 determines that the user 106 is charging their electric vehicle 104, the EVCS 102 receives vehicle characteristics associated with the electric vehicle 104 from a profile associated with the user 106. In some embodiments, upon connection, the EVCS 102 receives a media access control (MAC) address from the electric vehicle 104, and the EVCS 102 uses the MAC address to determine vehicle characteristics of the electric vehicle 104. The EVCS 102 can use a database to match the received MAC address or portions of the received MAC address to entries in the database to determine vehicle characteristics of the electric vehicle 104. For example, certain vehicle manufacturers keep portions of their produced electric vehicles' MAC addresses consistent. Accordingly, if the EVCS 102 determines that a portion of the MAC address received from the electric vehicle 104 corresponds to an electric vehicle manufacturer, the EVCS 102 can determine vehicle characteristics of the electric vehicle 104.

In some embodiments, the EVCS 102 can use the information captured by the one or more sensors to determine an estimated charge time. For example, the one or more sensors may determine that the electric vehicle's battery is 20% charged. Based on this information, the EVCS 102 can determine an estimated charge time (e.g., one hour). The EVCS 102 may determine the estimated charge time based on accessing a database where battery percentages correspond to estimated charge times. In some embodiments, the estimated charge time can be used in conjunction with and/or derived from information captured by the one or more other sensors. For example, using the camera 116, the EVCS 102 can determine the make and model of the electric vehicle 104, and a battery sensor can determine the battery percentage of the electric vehicle 104. The EVCS 102 can then access a database to determine the estimated charge time when using an optimal charging rate given the make, model, and battery percentage of the electric vehicle 104.

In some embodiments, the EVCS 102 can use estimated charge times to customize media displayed by the display 118. For example, if the estimated charge time of the electric vehicle 104 is a longer time frame, the EVCS 102 can determine that a first media item (e.g., movie ticket sale) may be more desirable to the user 102 of the electric vehicle 104 because the first media item corresponds to an activity with a longer time frame. If the estimated charge time of the electric vehicle 104 is a shorter time frame, the EVCS 102 can determine that a second media item (e.g., coffee sale) may be more desirable to the user 102 of the electric vehicle 104 because the second media item corresponds to an activity that can be completed more quickly. In some embodiments, the EVCS 102 customizes media to display based on other vehicle characteristics. For example, the EVCS 102 can determine the depth of the tire tread of the electric vehicle 104 using the one or more sensors and customize media items based on the condition of the tire tread. If the EVCS 102 determines that the tire tread is too shallow, the EVCS 102 can display media items (e.g., tire tread notification, tire sales, etc.) relating to the tire tread condition. In some embodiments, the customized media may be displayed on one or more user devices (e.g., the user device 108). For example, if the estimated charge time of the electric vehicle 104 is a longer time frame, the EVCS 102 can determine that a first media item (e.g., movie ticket sale) may be more desirable to the user 102. In some embodiments, the EVCS 102 can transmit the first media to the user device 108 as a notification. In some embodiments, the notification is a push notification. In some embodiments, the EVCS 102 transmits (e.g., via Bluetooth, Wi-Fi, etc.) the first media directly to the user device 108. In some embodiments, the EVCS 102 transmit the first media to the server 110 which then transmits the first media to the user device 108. In some embodiments, the user device 108 is connected to an application that receives information from the EVCS 102. In some embodiments, the user device 108 receives the first media from the application. In some embodiments, the server 110 receives information from the EVCS 102 (e.g., estimated charge time) and determines a media item to send to the user device 108 based on the received information. For example, estimated charge times spanning a first time period (e.g., two to three hours) may correspond to the first media item while estimated charge times spanning a second time period (e.g., five to ten minutes) may correspond to a second media item (e.g., coffee sale).

In some embodiments, the EVCS 102 allocates services to the electric vehicle 104 and/or user 106 based on the information captured by the one or more sensors, user information (e.g., user's calendar, user feedback, user patterns, user profile, etc.) and/or location information (e.g., electrical grid information, site information, etc.). In some embodiments, site information relates to the parameters of the EVCS's location. For example, newer locations (malls, shopping centers, etc.) may have more advanced electrical architecture allowing for higher output (e.g., higher charging rates) of electrical energy compared to locations with older electrical architecture. In some embodiments, user information and/or location information may be derived separately from the information captured using the one or more sensors, in conjunction with the information captured using the one or more sensors, or some combination thereof.

In some embodiments, the information collected by the EVCS 102 can be used to more efficiently train a machine learning algorithm. For example, training data may be identified using known events (e.g., when the EVCS 102 begins charging the electric vehicle 104, when the user 106 checks in, when the EVCS 102 detects a user device 108, etc.). Known events are beneficial as the information collected during the known events often contains helpful training data. For example, when the EVCS 102 begins charging the electric vehicle 104, the data received from the EVCS's one or more sensors (e.g., camera 116) will include video of the electric vehicle 104 being charged. The video data containing the electric vehicle can be helpful training data for a machine learning algorithm. In some embodiments, once the EVCS 102 determines that charging has begun, the EVCS 102 flags the video data received during the charging as data to be used to train the machine learning algorithm.

In some embodiments, the marked data can be used in conjunction with other information received by the EVCS 102 (e.g., vehicle characteristics) to increase the efficiency of the training of the machine learning process. In some embodiments, when the electric vehicle begins charging (known event), the EVCS 102 can flag the video data received from the camera 116. Upon connection, the EVCS 102 may also receive the make and model of the electric vehicle 104 using ISO 15118. The EVCS 102 can pair the vehicle characteristic information (e.g., make and model) with the flagged video data, generating training data for the machine learning algorithm. The generated training data comprises images of the electric vehicle 104 and the make and model of the electric vehicle 104, allowing the machine learning algorithm to be trained more efficiently.

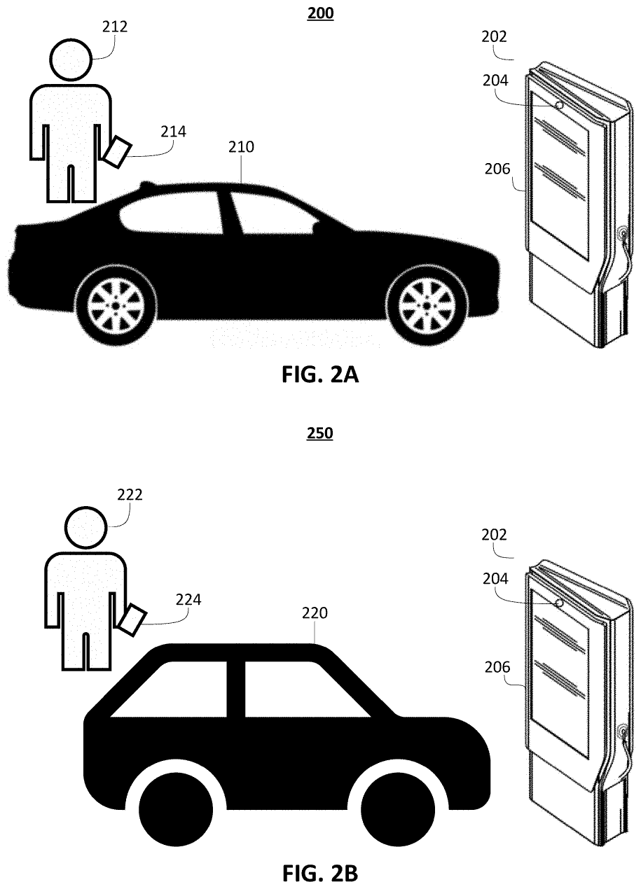

FIGS. 2A and 2B show illustrative diagrams of a system for allocating services based on characteristics of the vehicle being charged, in accordance with some embodiments of the disclosure. FIG. 2A shows a first electric vehicle 210 being detected by an EVCS 202. FIG. 2B shows a second electric vehicle 220 being detected by the EVCS 202. The EVCS 202 comprises a camera 204 and a display 206. In some embodiments, the EVCS 202 is the same as or similar to the EVCS 102 in FIG. 1 and comprises the same or similar components discussed above.

In some embodiments, the EVCS 202, using one or more sensors, determines that the first electric vehicle 210 comprises a 100-kWh battery and second electric vehicle 220 comprises an 80-kWh battery. The EVCS 202 can select a first charging rate at which to charge the first electric vehicle 210 and a second charging rate at which to charge the second electric vehicle 220. The EVCS 202 can select the first and second charging rates using a database, wherein the database indicates the optimal charging rate for different electric vehicles. In some embodiments, the EVCS 202 will determine the first and second charging rates based on other vehicle information. For example, the EVCS 202, using camera 204, can determine the first electric vehicle 210 is a first type (make and/or model) and the second electric vehicle 220 is second type. The EVCS 202 can select a first charging rate at which to charge the first electric vehicle 210 and a second charging rate at which to charge the second electric vehicle 220 based on the optimal charging rate for the different electric vehicle types.

In some embodiments, the EVCS 202, using one or more sensors, determines that the battery of the first electric vehicle 210 is 90% charged and charges the first electric vehicle 210 at a first charging rate. The EVCS 202 can determine, using one or more sensors, that the battery of the second electric vehicle 220 is 5% charged and charge the second electric vehicle 220 at a second charging rate. In some embodiments, the second charging rate may be faster than the first charging rate because the EVCS 202 determines that the second vehicle's battery is almost out of charge. In some embodiments, due to the first charging rate being slower, the first vehicle 210 is not subjected to unnecessarily fast charging rates, resulting in a prolonged lifespan of the first vehicle's battery. In some embodiments, the EVCS 202 determines the first and second charging rates based on the condition of the first electric vehicle's battery and the condition of the second electric vehicle's battery. For example, if the first electric vehicle 210 has a battery older than the second electric vehicle's, the EVCS 202 determines that first charging rate should be slower than the second charging rate. In some embodiments, due to the first charging rate being slower, the first vehicle 210 is not subjected to unnecessarily fast charging rates, which would result in decreased battery degradation.

In some embodiments, the EVCS 202, using user information, determines an estimated charge time. For example, when the first electric vehicle 210 begins charging at the EVCS 202, the EVCS 202 determines that the first user 212 will participate in an activity (e.g., watching a movie) by checking a calendar of the first user 212. In some embodiments, the EVCS 202 determines a first estimated charge time (e.g., two hours) based on the activity. The EVCS 202 can determine a first charging rate at which to charge the first electric vehicle 210 based on the first estimated charge time. In some embodiments, when the second electric vehicle 220 begins charging at the EVCS 202, the EVCS 202 determines that the second user 212 will participate in a second activity (e.g., picking up a to-go order) by checking a profile of the second user 222. In some embodiments, the EVCS 202 determines a second estimated charge time (e.g., ten minutes) based on the second activity. The EVCS 202 can determine a second charging rate at which to charge the second electric vehicle 220 based on the second estimated charge time. In some embodiments, the second charging rate is faster than the first charging rate because the EVCS 202 determines that the second vehicle's estimated charge time is less than the first vehicle's estimated charge time. In some embodiments, as the first user 212 watches the movie, the first vehicle 210 is not subjected to unnecessarily fast charging rates, resulting in a prolonged lifespan of the first vehicle's battery.

In some embodiments, the EVCS 202 uses location information (e.g., electrical grid information) to determine a charging rate. For example, when the first electric vehicle 210 arrives at a peak electrical time (e.g., noon in the middle of summer in Arizona) and begins charging, the EVCS 202 can determine a first charging rate at which to charge the first electric vehicle 210. When the second electric vehicle 220 arrives at a non-peak electrical time (e.g., 8:00 am in the middle of fall in Arizona) and begins charging, the EVCS 202 can determine a second charging rate at which to charge the second electric vehicle 220. The EVCS 202 can determine, using electric grid information, that the first vehicle's charging rate needs to be slower to decrease load on the electrical grid during the peak time. In some embodiments, the first charging rate is slower than the second charging rate, decreasing load on the electrical grid.

In some embodiments, the EVCS 202 uses location information, user information, and/or information captured from the one or more sensors to determine a charging rate. For example, the EVCS can determine the first estimated charge time (e.g., two hours) using user information and/or information captured from the one or more sensors. When the first electric vehicle 210 arrives during a peak electrical time and begins charging, the EVCS 202 can determine a first charging rate at which to charge the first electric vehicle 210 using electrical grid information and the first estimated charge time (e.g., two hours). In some embodiments, the first charging rate may be the EVCS 202 providing little to no charge for the first hour and a half of the two-hour estimated charge time when the electrical grid load is at a peak. The first charging rate may result in the EVCS 202 providing a more rapid charge for the last half hour (during a non-peak electrical time) of the first estimated charge time. In some embodiments, the EVCS 202 determines the first charging rate to reduce load on the electrical grid during the peak times.

In some embodiments, the EVCS 202 uses location information, user information, and/or information captured from the one or more sensors to customize media items to display to the users of the electric vehicles. For example, if the EVCS 202 determines that the first electric vehicle's battery is 5% charged and the second electric vehicle's battery is 90% charged, the EVCS determines that the first estimated charge time for the first electric vehicle 210 will be longer than the second estimated charge time for the second electric vehicle 220. In some embodiments, the EVCS 202 determines that a first media item (e.g., movie ticket sale) may be more desirable to the first user 212 because the first media item corresponds to an activity with a longer time frame. In some embodiments, the EVCS 202 makes this determination using a database that contains entries where media items correspond to estimated charge times. The first media item may be more desirable to the first user 212 because the first electric vehicle's battery takes longer to optimally charge so the first user 212 has more available time. In some embodiments, the EVCS 202 determines that a second media item (e.g., coffee sale) may be more desirable to the second user 222 because the second media item corresponds to an activity that can be completed more quickly. The second media item is more desirable to the second user 222 because the second electric vehicle's battery does not require as much time to optimally charge meaning the second user 222 has less available time.

In some embodiments, the EVCS 202 determines the depth of the tire tread of the first electric vehicle 210 using the one or more sensors (e.g., camera 204) and customizes media items presented on the display 206 based on the condition of the tire tread. In some embodiments, the EVCS 202 determines that the tire tread of the first electric vehicle 210 is too shallow and displays a first media item relating to the tire tread condition (e.g., tire tread notification, tire sales, etc.).

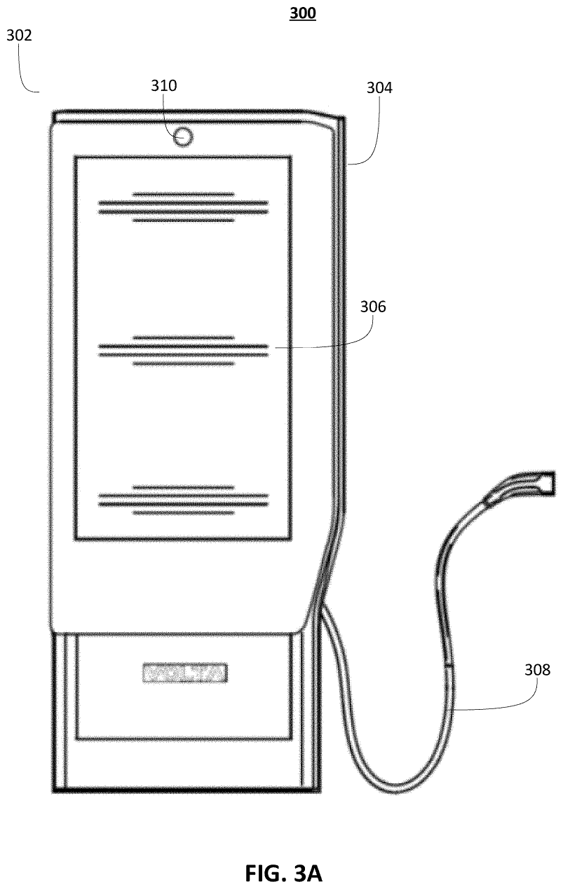

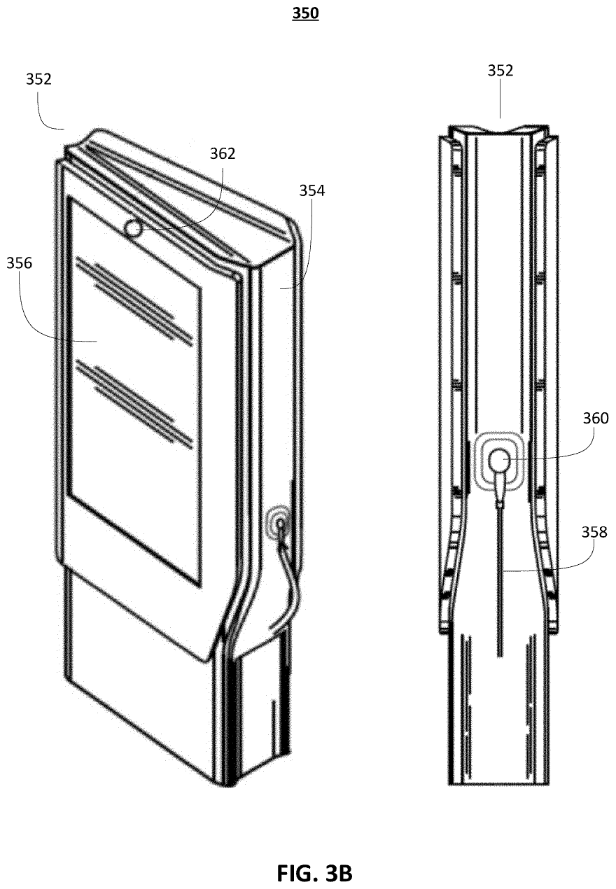

FIG. 3A illustrates an EVCS used for allocating services based on characteristics of the electric vehicle being charged, in accordance with some embodiments of the disclosure. In some embodiments, FIG. 3A illustrates the EVCSs displayed in FIGS. 1, 2A, and 2B. The EVCS 302 includes a housing 304 (e.g., a body or a chassis) that holds a display 306. In some embodiments, the EVCS 302 comprises more than one display. For example, the EVCS 302 may have a first display 306 and a second display (on the other side of the EVCS 302). In some embodiments, the display 306 is large compared to the housing 304 (e.g., 60% or more of the height of the frame and 80% or more of the width of the frame), allowing the display 306 to function as a billboard, capable of conveying information to passersby. In some embodiments, the one or more displays 306 display messages (e.g., media items) to users of the EVCS 302 (e.g., operators of the electric vehicle) and/or to passersby that are in proximity to the EVCS 302. In some embodiments, the display 306 has a height that is at least three feet and a width that is at least two feet.

The EVCS 302 further comprises a computer that includes one or more processors and memory. In some embodiments, the memory stores instructions for displaying content on the display 306. In some embodiments, the computer is disposed inside the housing 304. In some embodiments, the computer is mounted on a panel that connects (e.g., mounts) a first display (e.g., a display 306) to the housing 304. In some embodiments, the computer includes a near-field communication (NFC) system that is configured to interact with a user's device (e.g., user device 108 of a user 106 in FIG. 1).

The EVCS 302 further comprises a charging cable 308 (e.g., connector) configured to connect and provide a charge to an electric vehicle (e.g., electric vehicle 104 of FIG. 1). In some embodiments, the charging cable 308 is an IEC 62196 type-2 connector. In some embodiments, the charging cable 308 is a “gun-type” connector (e.g., a charge gun) that, when not in use, sits in a holder (e.g., a holster). In some embodiments, the housing 304 houses circuitry for charging an electric vehicle. For example, in some embodiments, the housing 304 includes power supply circuitry as well as circuitry for determining a state of a vehicle being charged (e.g., whether the vehicle is connected via the connector, whether the vehicle is charging, whether the vehicle is done charging, etc.). In some embodiments, the EVCS 302 supports ISO 15118, which allows a user to plug their electric vehicle into the EVCS 302 and begin charging without inputting any additional information. ISO 15118 is a communication interface, which, among other things, can identify the make and model of an electric vehicle to an EVCS. When an electric vehicle that supports ISO 15118 begins charging, the EVCS 302 can receive vehicle characteristics (e.g., make and model of the electric vehicle) using ISO 15118.

The EVCS 302 further comprises one or more cameras 310 configured to capture one or more images of an area proximal to the EVCS 302. In some embodiments, the one or more cameras 310 are configured to obtain video of an area proximal to the EVCS 302. For example, a camera may be configured to obtain a video or capture images of an area corresponding to a parking spot associated with the EVCS 302. In another example, another camera may be configured to obtain a video or capture images of an area corresponding to a parking spot next to the parking spot of the EVCS 302. In some embodiments, the camera 310 shown in FIG. 3A may be a wide-angle camera or a 360° camera that is configured to obtain a video or capture images of a large area proximal to the EVCS 302. The one or more cameras 310 may be mounted directly on the housing 304 of the EVCS 302 and may have a physical (e.g., electrical, wired) connection to the EVCS 302 or a computer system associated with the EVCS 302. In some embodiments, the one or more cameras 310 (or other sensors) may be disposed separately from but proximal to the housing 304 of the EVCS 302. In some embodiments, the camera 310 may be positioned at different locations on the EVCS 302 than what is shown. In some embodiments, the one or more cameras 310 include a plurality of cameras positioned at different locations on the EVCS 302.

In some embodiments, the EVCS 302 further comprises one or more sensors (not shown). In some embodiments, the one or more sensors detect external objects within a region (area) proximal to the EVCS 302. In some embodiments, the area proximal to the EVCS 302 includes one or more parking spaces, where an electric vehicle parks in order to use the EVCS 302. In some embodiments, the area proximal to the EVCS 302 includes walking paths (e.g., sidewalks) next to the EVCS 302. In some embodiments, the one or more sensors are configured to determine a state of the area proximal to the EVCS 302 (e.g., wherein determining the state includes detecting external objects or the lack thereof). In some embodiments, the external objects can be living or nonliving, such as people, kids, animals, vehicles, shopping carts, toys, etc. In some embodiments, the one or more sensors can detect stationary or moving external objects. In some embodiments, the one or more sensors may be one or more image sensors (e.g., one or more cameras 310), ultrasound sensors, depth sensors, IR cameras, RGB cameras, PIR cameras, heat IR, proximity sensors, radar, tension sensors, NFC sensors, and/or any combination thereof. The one or more sensors may be connected to the EVCS 302 or a computer system associated with the EVCS 302 via wired or wireless connections such as a Wi-Fi connection or Bluetooth connection.

In some embodiments, the EVCS 302 further comprises one or more lights configured to provide predetermined illumination patterns indicating a status of the EVCS 302. In some embodiments, at least one of the one or more lights is configured to illuminate an area proximal to the EVCS 302 as a person approaches the area (e.g., a driver returning to a vehicle or a passenger exiting a vehicle that is parked in a parking spot associated with the EVCS 302).

FIG. 3B illustrates an EVCS 352 used for allocating services based on characteristics of the electric vehicle being charged, in accordance with some embodiments of the disclosure. In some embodiments, FIG. 3B illustrates the EVCSs displayed in FIGS. 1, 2A, 2B, and 3A. In some embodiments, FIG. 3B displays additional views of the EVCS 302 shown in FIG. 3A. For example, the EVCS 352 comprises housing 354, one or more displays 356, charging cable 358, charging cable holder 360, and one or more cameras 362.

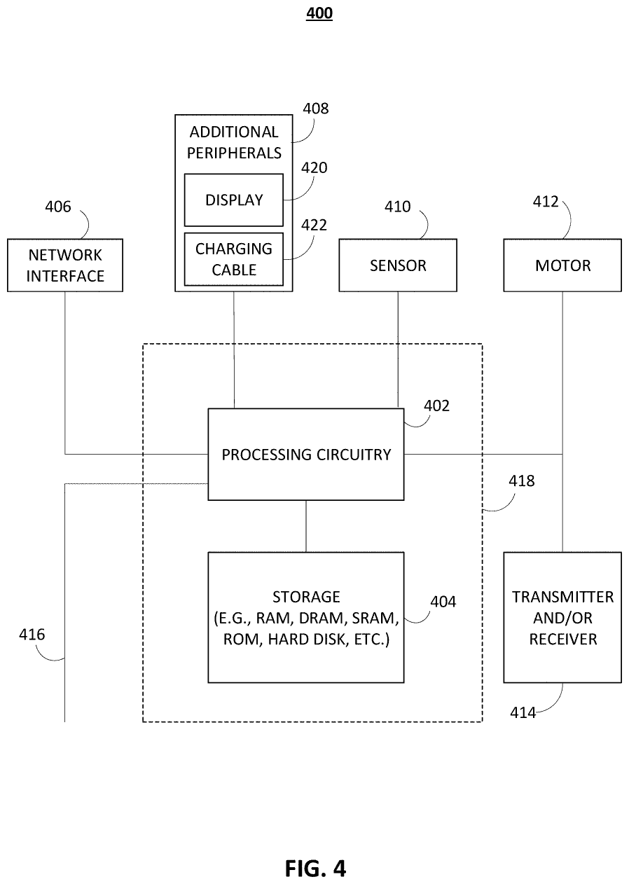

FIG. 4 shows an illustrative block diagram of an EVCS system 400, in accordance with some embodiments of the disclosure. In particular, the EVCS system 400 of FIG. 4 may be any of the EVCSs depicted in FIGS. 1-3B. In practice, and as recognized by those of ordinary skill in the art, items shown separately could be combined, and some items could be separated. In some embodiments, not all shown items must be included in the EVCS 400. In some embodiments, the EVCS 400 may comprise additional items.

The EVCS system 400 can include processing circuitry 402, which includes one or more processing units (processors or cores), storage 404, one or more network or other communications network interfaces 406, additional peripherals 408, one or more sensors 410, a motor 412 (configured to retract a portion of a charging cable), one or more wireless transmitters and/or receivers 414, and one or more input/output (I/O) paths 416. I/O paths 416 may use communication buses for interconnecting the described components. I/O paths 416 can include circuitry (sometimes called a chipset) that interconnects and controls communications between system components. The EVCS 400 may receive content and data via I/O paths 416. The I/O path 416 may provide data to control circuitry 418, which includes processing circuitry 402 and a storage 404. The control circuitry 418 may be used to send and receive commands, requests, and other suitable data using the I/O path 416. The I/O path 416 may connect the control circuitry 418 (and specifically the processing circuitry 402) to one or more communications paths. I/O functions may be provided by one or more of these communications paths but are shown as a single path in FIG. 4 to avoid overcomplicating the drawing.

The control circuitry 418 may be based on any suitable processing circuitry such as the processing circuitry 402. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The allocation-of-services functionality can be at least partially implemented using the control circuitry 418. The allocation-of-services functionality described herein may be implemented in or supported by any suitable software, hardware, or combination thereof. The allocation of services can be implemented on user equipment, on remote servers, or across both.

The control circuitry 418 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 404 that is part of the control circuitry 418. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 404 includes one or more storage devices remotely located, such as database of server system that is in communication with the EVCS 400. In some embodiments, the storage 404, or alternatively the non-volatile memory devices within the storage 404, includes a non-transitory computer-readable storage medium.

In some embodiments, storage 404 or the computer-readable storage medium of the storage 404 stores an operating system, which includes procedures for handling various basic system services and for performing hardware-dependent tasks. In some embodiments, storage 404 or the computer-readable storage medium of the storage 404 stores a communications module, which is used for connecting the EVCS 400 to other computers and devices via the one or more communication network interfaces 406 (wired or wireless), such as the internet, other wide area networks, local area networks, metropolitan area networks, and so on. In some embodiments, storage 404 or the computer-readable storage medium of the storage 404 stores a media item module for selecting and/or displaying media items on the display(s) 420 to be viewed by passersby and users of the EVCS 400. In some embodiments, storage 404 or the computer-readable storage medium of the storage 404 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 404 stores a subset of the modules and data structures identified above. In some embodiments, the storage 404 may store additional modules or data structures not described above.

In some embodiments, the EVCS 400 comprises additional peripherals 408 such as displays 420 for displaying content, and charging cable 422. In some embodiments, the displays 420 may be touch-sensitive displays that are configured to detect various swipe gestures (e.g., continuous gestures in vertical and/or horizontal directions) and/or other gestures (e.g., a single or double taps) or to detect user input via a soft keyboard that is displayed when keyboard entry is needed.

In some embodiments, the EVCS 400 comprises one or more sensors 410 such as cameras (e.g., cameras, described above with respect to FIGS. 1-3B), ultrasound sensors, depth sensors, IR cameras, RGB cameras, PIR cameras, heat IR, proximity sensors, radar, tension sensors, NFC sensors, and/or any combination thereof. In some embodiments, the one or more sensors 410 are for detecting whether external objects are within a region proximal to the EVCS 400, such as living and nonliving objects, and/or the status of the EVCS 400 (e.g., available, occupied, etc.) in order to perform an operation, such as determining a vehicle characteristic, user information, region status, appropriate allocation of services, etc.

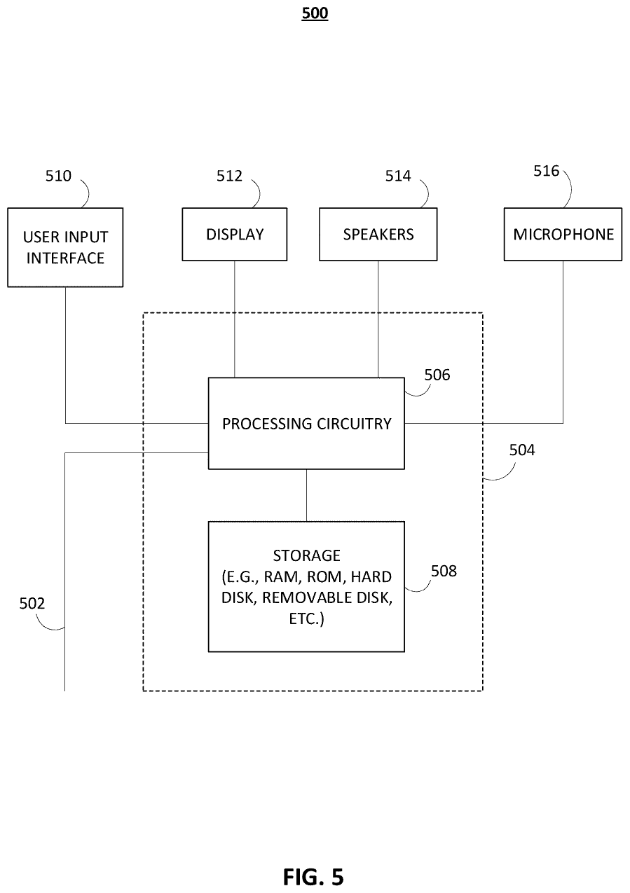

FIG. 5 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 500. In some embodiments, device 500 may comprise additional items. In an embodiment, the user equipment device 500 is the same user equipment device 108 of FIG. 1. The user equipment device 500 may receive content and data via I/O path 502. The I/O path 502 may provide audio content (e.g., broadcast programming, on-demand programming, internet content, content available over a local area network (LAN) or wide area network (WAN), and/or other content) and data to control circuitry 504, which includes processing circuitry 506 and a storage 508. The control circuitry 504 may be used to send and receive commands, requests, and other suitable data using the I/O path 502. The I/O path 502 may connect the control circuitry 504 (and specifically the processing circuitry 506) to one or more communications paths. I/O functions may be provided by one or more of these communications paths but are shown as a single path in FIG. 5 to avoid overcomplicating the drawing.

The control circuitry 504 may be based on any suitable processing circuitry such as the processing circuitry 506. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client/server-based embodiments, the control circuitry 504 may include communications circuitry suitable for communicating with one or more servers that may at least implement the described allocation of services functionality. The instructions for carrying out the above-mentioned functionality may be stored on the one or more servers. Communications circuitry may include a cable modem, an ISDN modem, a DSL modem, a telephone modem, Ethernet card, or a wireless modem for communications with other equipment, or any other suitable communications circuitry. Such communications may involve the internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 508 that is part of the control circuitry 504. Storage 508 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid-state devices, quantum storage devices, gaming consoles, gaming media, or any other suitable fixed or removable storage devices, and/or any combination of the same. The storage 508 may be used to store various types of content described herein. Nonvolatile memory may also be used (e.g., to launch a boot-up routine and other instructions). Cloud-based storage may be used to supplement the storage 508 or instead of the storage 508.

The control circuitry 504 may include audio generating circuitry and tuning circuitry, such as one or more analog tuners, audio generation circuitry, filters or any other suitable tuning or audio circuits or combinations of such circuits. The control circuitry 504 may also include scaler circuitry for upconverting and converting down content into the preferred output format of the user equipment device 500. The control circuitry 504 may also include digital-to-analog converter circuitry and analog-to-digital converter circuitry for converting between digital and analog signals. The tuning and encoding circuitry may be used by the user equipment device 500 to receive and to display, play, or record content. The circuitry described herein, including, for example, the tuning, audio generating, encoding, decoding, encrypting, decrypting, scaler, and analog/digital circuitry, may be implemented using software running on one or more general purpose or specialized processors. If the storage 508 is provided as a separate device from the user equipment device 500, the tuning and encoding circuitry (including multiple tuners) may be associated with the storage 508.

The user may utter instructions to the control circuitry 504, which are received by the microphone 516. The microphone 516 may be any microphone (or microphones) capable of detecting human speech. The microphone 516 is connected to the processing circuitry 506 to transmit detected voice commands and other speech thereto for processing. In some embodiments, voice assistants (e.g., Siri, Alexa, Google Home and similar such voice assistants) receive and process the voice commands and other speech.

The user equipment device 500 may optionally include an interface 510. The interface 510 may be any suitable user interface, such as a remote control, mouse, trackball, keypad, keyboard, touch screen, touchpad, stylus input, joystick, or other user input interfaces. A display 512 may be provided as a stand-alone device or integrated with other elements of the user equipment device 500. For example, the display 512 may be a touchscreen or touch-sensitive display. In such circumstances, the interface 510 may be integrated with or combined with the microphone 516. When the interface 510 is configured with a screen, such a screen may be one or more of a monitor, a television, a liquid crystal display (LCD) for a mobile device, active matrix display, cathode ray tube display, light-emitting diode display, organic light-emitting diode display, quantum dot display, or any other suitable equipment for displaying visual images. In some embodiments, the interface 510 may be HDTV-capable. In some embodiments, the display 512 may be a 3D display. The speaker (or speakers) 514 may be provided as integrated with other elements of user equipment device 500 or may be a stand-alone unit. In some embodiments, the display 512 may be outputted through speakers 514.

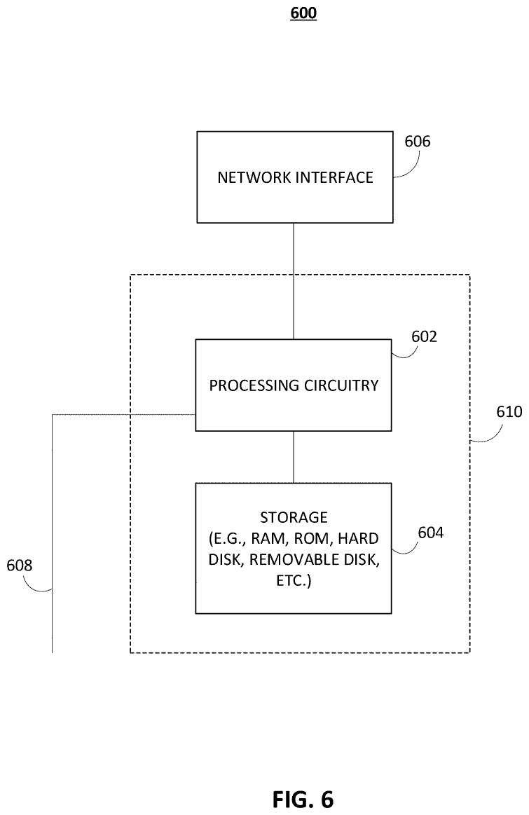

FIG. 6 shows an illustrative block diagram of a server system 600, in accordance with some embodiments of the disclosure. Server system 600 may include one or more computer systems (e.g., computing devices), such as a desktop computer, a laptop computer, and a tablet computer. In some embodiments, the server system 600 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 600. In some embodiments, server system 600 may comprise additional items.

The server system 600 can include processing circuitry 602, which includes one or more processing units (processors or cores), storage 604, one or more network or other communications network interfaces 606, and one or more input/output I/O paths 608. I/O paths 608 may use communication buses for interconnecting the described components. I/O paths 608 can include circuitry (sometimes called a chipset) that interconnects and controls communications between system components. Server system 600 may receive content and data via I/O paths 608. The I/O path 608 may provide data to control circuitry 610, which includes processing circuitry 602 and a storage 604. The control circuitry 610 may be used to send and receive commands, requests, and other suitable data using the I/O path 608. The I/O path 608 may connect the control circuitry 610 (and specifically the processing circuitry 602) to one or more communications paths. I/O functions may be provided by one or more of these communications paths but are shown as a single path in FIG. 6 to avoid overcomplicating the drawing.

The control circuitry 610 may be based on any suitable processing circuitry such as the processing circuitry 602. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 604 that is part of the control circuitry 610. Storage 604 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 604 or the computer-readable storage medium of the storage 604 stores an operating system, which includes procedures for handling various basic system services and for performing hardware-dependent tasks. In some embodiments, storage 604 or the computer-readable storage medium of the storage 604 stores a communications module, which is used for connecting the server system 600 to other computers and devices via the one or more communication network interfaces 606 (wired or wireless), such as the internet, other wide area networks, local area networks, metropolitan area networks, and so on. In some embodiments, storage 604 or the computer-readable storage medium of the storage 604 stores a web browser (or other application capable of displaying web pages), which enables a user to communicate over a network with remote computers or devices. In some embodiments, storage 604 or the computer-readable storage medium of the storage 604 stores a database for storing information on electric vehicle charging stations, their locations, media items displayed at respective electric vehicle charging stations, a number of each type of impression count associated with respective electric vehicle charging stations, and so forth.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 604 stores a subset of the modules and data structures identified above. In some embodiments, the storage 604 may store additional modules or data structures not described above.

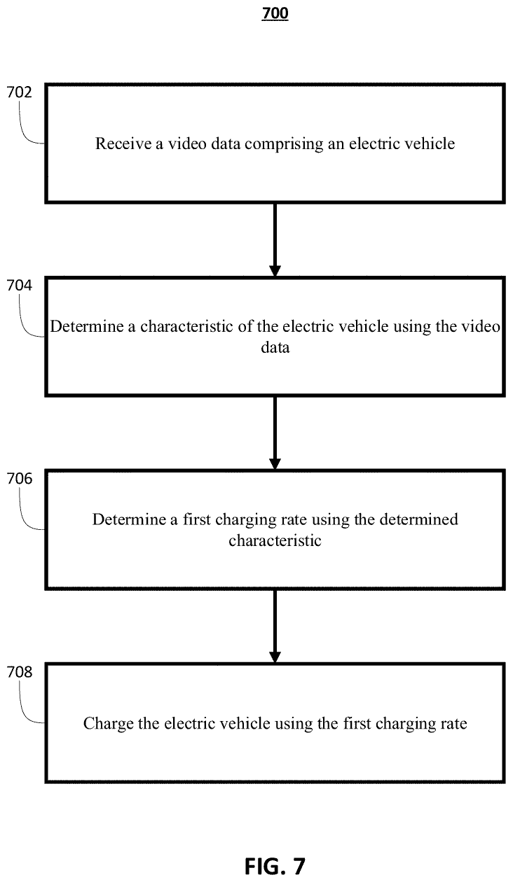

FIG. 7 is an illustrative flowchart of a process 700 for determining a charging rate based on a characteristic of an electric vehicle, in accordance with some embodiments of the disclosure. Process 700 may be performed by physical or virtual control circuitry, such as control circuitry 418 of an EVCS (FIG. 4). In some embodiments, some steps of process 700 may be performed by one of several devices.

At step 702, control circuitry receives video data comprising an electric vehicle. In some embodiments, the video data is captured using one or more sensors of an EVCS. In some embodiments, the one or more sensors are continually capturing information and sending the information to the control circuitry. In some embodiments, the control circuitry instructs the one or more sensors to capture video data in response to detecting an electric vehicle. In some embodiments, the control circuitry detects the electric vehicle using the one or more sensors. In some embodiments, the one or more sensors detect the electric vehicle when the electric vehicle is within a threshold distance of the EVCS. In some embodiments, the one or more sensors detect the electric vehicle when the EVCS's charging cable is plugged into the electric vehicle. In some embodiments, the control circuitry receives the video data from the one or more sensors in response to detecting an electric vehicle.

At step 704, control circuitry determines a characteristic of the electric vehicle using the video data. In some embodiments, the control circuitry uses a machine learning algorithm to process the video data to determine one or more characteristics corresponding to the electric vehicle. In some embodiments, the one or more characteristics include vehicle model, vehicle make, vehicle specifications, vehicle condition, and/or similar such information. In some embodiments, other information captured from the one or more sensors and/or user information is used in conjunction with or independent of the video data to determine the one or more characteristics of the electric vehicle.

At step 706, control circuitry determines a first charging rate using the determined characteristic. In some embodiments, the control circuitry accesses a database comprising a plurality of entries wherein vehicle characteristics are mapped to charging rates. In some embodiments, the control circuitry determines that a first entry, corresponding to the determined vehicle characteristic, indicates a first charging rate. In some embodiments, the control circuitry uses more than one entry to determine the first charging rate. In some embodiments, the control circuitry uses more than one vehicle characteristic to determine the first charging rate. In some embodiments, the control circuitry weighs one or more vehicle characteristics to determine an optimal charging rate. For example, the electric vehicle's model type can indicate a first charging rate, and the electric vehicle's condition can indicate a second charging rate. The control circuitry may determine that the electric vehicle's model type is weighted higher than the electric vehicle's condition and determine that the first charging rate should be used. In some embodiments, the control circuitry may use the first and second charging rates to determine a third charging rate that is used to charge the electric vehicle. The third charging rate may be between the first and second charging rates and/or may be calculated using the weighted average of the first and second charging rates.

At step 708, control circuitry charges the electric vehicle using the charging rate determined in step 706. In some embodiments, the control circuitry notifies the user of the electric vehicle of the charging rate. In some embodiments, the control circuitry offers the user an option to select a different charging rate. In some embodiments, the different charging rates may be more expense and/or may come with warnings.

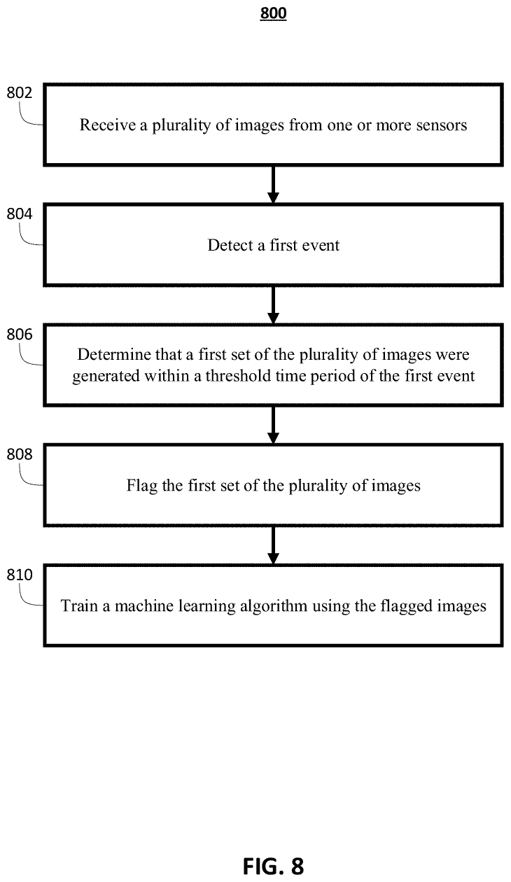

FIG. 8 is an illustrative flowchart of a process 800 for determining a charging rate based on a characteristic of an electric vehicle, in accordance with some embodiments of the disclosure. Process 800 may be performed by physical or virtual control circuitry, such as control circuitry 418 of an EVCS (FIG. 4). In some embodiments, some steps of process 800 may be performed by one of several devices.

At step 802, control circuitry receives a plurality of images from one or more sensors. In some embodiments, the images are captured using one or more sensors of an EVCS. In some embodiments, the one or more sensors continuously capture images and send the information to the control circuitry. In some embodiments, the one or more sensors capture images in response to a request from the control circuitry.

At step 804, control circuitry detects a first event. In some embodiments, the first event relates to a known event, where the known event indicates that an electric vehicle may be detectable. In some embodiments, the control circuitry detects the known event using the one or more sensors of the EVCS. In some embodiments, the control circuitry detects the known event when one or more sensors detects an electric vehicle within a threshold distance of the EVCS. In some embodiments, the control circuitry detects the known event when the EVCS's charging cable is plugged into an electric vehicle. In some embodiments, the control circuitry detects the known event when the user of the electric vehicle checks in using a user device. In some embodiments, the first event corresponds to a point in time (e.g., 3:30 pm). In some embodiments, the first event corresponds to a range of time (e.g., 3:30 pm-3:32 pm). In some embodiments, a detection of the first event is the result of the detection of one or more known events. For example, the control circuitry may detect a first event only if the one or more sensors detects an electric vehicle within a threshold distance of the EVCS and the EVCS's charging cable is plugged into the electric vehicle.

At step 806, control circuitry determines that a first set of the plurality of images was generated within a threshold time period of the first event. In some embodiments, the plurality of images received from the one or more sensors correspond to a point in time. For example, each image may have a time stamp located in the metadata of the image. In some embodiments, control circuitry determines a threshold time period of the first event. For example, if the first event occurred at 3:30 pm, the threshold time period may be five minutes before and after the occurrence of the first event (3:25 pm-3:35 pm). In some embodiments, the length or type of threshold time period is determined based on the type of event. In some embodiments, the threshold time period corresponds to the range of time of the first event itself. In some embodiments, the control circuitry selects one or more of the plurality of images received from the one or more sensors, where the selected images are associated with the threshold time period. The selected images make up the first set of the plurality of images. In some embodiments, the number of images selected for the first set of the plurality of images corresponds to the type of event. In some embodiments, the images selected for the first set of the plurality of images correspond to all images of the received plurality of images that correspond to the threshold time period.

At step 808, control circuitry flags the first set of the plurality of images. In some embodiments, the control circuitry marks the first set of the plurality of images as training data for a machine learning algorithm.

At step 810, the flagged images are used to train a machine learning algorithm. In some embodiments, vehicle characteristics are used in conjunction with the flagged images to increase the efficiency of the training of the machine learning process. For example, when an electric vehicle that supports ISO 15118 begins charging (known event), the control circuitry can flag the first set of the plurality of images received from the sensors during the threshold time period and also receive vehicle characteristics (make and model of the electric vehicle) using ISO 15118. In some embodiments, the control circuitry pairs the vehicle characteristics with the first set of the plurality of images to allow for more efficient training of the machine learning algorithm. In some embodiments, the flagged images may also be used to sort and retrieve images according to the vehicle characteristics.

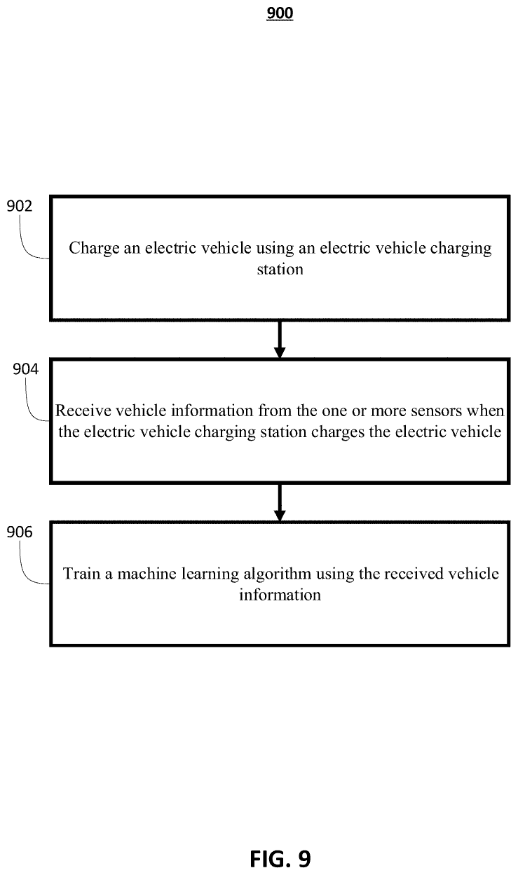

FIG. 9 is an illustrative flowchart of a process 900 for determining a charging rate based on a characteristic of an electric vehicle, in accordance with some embodiments of the disclosure. Process 900 may be performed by physical or virtual control circuitry, such as control circuitry 418 of an EVCS (FIG. 4). In some embodiments, some steps of process 900 may be performed by one of several devices.

At step 902, control circuitry of an EVCS charges an electric vehicle. In some embodiments, the EVCS is stationary, and the EVCS receives information from its one or more sensors corresponding to a first area. In some embodiments, the first area is a standard area that does not change.

At step 904, while the EVCS charges the electric vehicle, the control circuitry receives vehicle information using the one or more sensors. In some embodiments, the control circuitry instructs the one or more sensors to capture video data in response to detecting an electric vehicle. In some embodiments, the one or more sensors detects the electric vehicle when the electric vehicle is within a threshold distance of the EVCS. In some embodiments, the one or more sensors detects the electric vehicle when the EVCS's charging cable is plugged into the electric vehicle. In some embodiments, the control circuitry determines that a portion of the vehicle information should be used as training data for a machine learning algorithm and marks the portion of the received vehicle information.

In some embodiments, the EVCS selects, from images captured by a camera at the EVCS, only those images that include an electric vehicle. In some embodiments, to determine which images include an electric vehicle, the disclosed embodiments make use of a change in the state (also referred to as a status) of the EVCS. For example, the change in the state of the EVCS may correspond to an electric vehicle being electrically connected to the EVCS, or an operator of the electric vehicle “checking in” to the EVCS on their mobile phone. Images captured by the camera that correspond to the change of state are thus determined to be images of an electric vehicle. This allows the EVCS's camera to continuously perform other tasks (e.g., performing image recognition) while simultaneously obtaining data that can be used to train a machine learning model to recognize electric vehicles.

At step 906, the collected vehicle information is used to train a machine learning algorithm. In some embodiments, it takes less time to train the machine learning algorithm using the collected vehicle information due to the assumption of known parameters (e.g., first area where the EVCS is located). In some embodiments, less data is required to train the machine learning algorithm when using the collected vehicle information due to the assumption of known parameters (e.g., first area where the EVCS is location).

In some embodiments, prior to training the machine learning model, a subset of images (e.g., only the subset of images) is tagged. In some embodiments, the tagging is performed by a human. Rather than having to sort through an entire video feed, the human tagger only has to tag images that have already been identified as including an electric vehicle, thus improving the efficiency of the human tagging process. In other embodiments, information from the EVCS is used to tag (e.g., as metadata) the characteristics of the electric vehicle without human intervention. For example, information about the make, model, and year of the electric vehicle is provided through the charging cable and used to tag the images. In another example, the characteristics of the electric vehicle are stored in a profile of the user who checks in to the electric vehicle charging station, and those characteristics are used to tag the images without human intervention, thus reducing or eliminating altogether the need for human taggers.

It is contemplated that some suitable steps or suitable descriptions of FIGS. 7-9 may be used with other suitable embodiments of this disclosure. In addition, some suitable steps and descriptions described in relation to FIGS. 7-9 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-6 could be used to perform one or more of the steps in FIGS. 7-9.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. An electric vehicle charging station comprising:
a housing unit;
a connector, coupled to the housing unit, for delivering an electrical charge to an electric vehicle; and
a processor located inside the housing unit, the processor configured to:
receive a first set of images comprising the electric vehicle;
determine a characteristic of the electric vehicle using the first set of images; and
charge the electric vehicle with the connector using a first charging rate, wherein the first charging rate is based on the determined characteristic.

2. The electric vehicle charging station of claim 1, wherein the processor is further configured to determine a second characteristic of the electric vehicle using the first set of images, wherein the first charging rate is based on the determined characteristic and the second characteristic.

3. The electric vehicle charging station of claim 1, further comprising a display coupled to the housing unit, wherein the processor is further configured to display a media item based on the determined characteristic on the display coupled to the housing unit.

4. The electric vehicle charging station of claim 1, wherein the characteristic corresponds to a model of the electric vehicle.

5. The electric vehicle charging station of claim 1, wherein the characteristic corresponds to an amount of charge stored in a battery of the electric vehicle.

6. The electric vehicle charging station of claim 1, further comprising a first sensor coupled to the electric vehicle charging station, wherein the first set of images are received using the first sensor.

7. The electric vehicle charging station of claim 1, wherein the first charging rate corresponds to a first amount of current during a first time period.

8. The electric vehicle charging station of claim 1, wherein the first charging rate corresponds to a first amount of current during a first time period and a second amount of current during a second time period.

9. The electric vehicle charging station of claim 1, wherein the processor is further configured to:
receive a second set of images comprising a second electric vehicle;
determine a second characteristic of the second electric vehicle using the second set of images; and
charge the second electric vehicle using a second charging rate, wherein the second charging rate is based on the second characteristic.

10. A method comprising:
receiving, by an electric vehicle charging station, a first set of images comprising an electric vehicle;
determining, by the electric vehicle charging station, a characteristic of the electric vehicle using the first set of images; and
charging, by the electric vehicle charging station, the electric vehicle using a first charging rate, wherein the first charging rate is based on the determined characteristic.

11. The method of claim 10, wherein the characteristic corresponds to a model of the electric vehicle.

12. The method of claim 10, further comprising displaying a media item based on the determined characteristic on a display coupled to the electric vehicle charging station.

13. The method of claim 10, wherein the characteristic corresponds to an amount of charge stored in a battery of the electric vehicle.

14. The method of claim 10, wherein the electric vehicle charging station comprises a first sensor and the first set of images are received using the first sensor.

15. The method of claim 10, wherein the first charging rate corresponds to a first amount of current during a first time period.

16. The method of claim 10, further comprising:
receiving, by the electric vehicle charging station, a second set of images comprising a second electric vehicle;
determining, by the electric vehicle charging station, a second characteristic of the second electric vehicle using the second set of images; and
charging, by the electric vehicle charging station, the second electric vehicle using a second charging rate, wherein the second charging rate is based on the second characteristic.

17. A non-transitory computer-readable medium having instructions encoded thereon that when executed by control circuitry causes the control circuitry to:
receive a first set of images comprising an electric vehicle;
determine a characteristic of the electric vehicle using the first set of images; and
charge the electric vehicle using a first charging rate, wherein the first charging rate is based on the determined characteristic.

18. The non-transitory computer-readable medium of claim 17, wherein the control circuitry is further caused to:
receive a second set of images comprising a second electric vehicle;
determine a second characteristic of the second electric vehicle using the second set of images; and
charge the second electric vehicle using a second charging rate, wherein the second charging rate is based on the second characteristic.

19. The non-transitory computer-readable medium of claim 18, wherein the first charging rate corresponds to a first amount of current during a first time period and the second charging rate corresponds to a second amount of current during a second time period.

20. The non-transitory computer-readable medium of claim 17, wherein the control circuitry is further caused to display a media item based on the determined characteristic on a display coupled to the electric vehicle charging station.

21.-59. (canceled)
